(19) United States
(12) Patent Application Publication
(10) Pub. No.: US 2004/0096766 A1
(43) Pub. Date: May 20, 2004

(54) Developing agent

(75) Inventors: Takashi Urabe, Shizuoka-ken (JP); Shuitsu Sato, Tokyo (JP); Yasuhito Noda, Mishima-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/293,323

(22) Filed: Nov. 14, 2002

(51) Int. Cl. G03G 9/087; G03G 9/097

(52) U.S. Cl. 430/109.4; 430/108.8

(57) ABSTRACT

A binder resin contains a polyester resin, a crystalline polyester resin, a wax having a DSC heat absorption peak temperature not higher than that of the crystalline polyester resin, and another wax having a DSC heat absorption peak temperature higher than that of the crystalline polyester resin.

### BACKGROUND OF THE INVENTION

The present invention relates to a developing agent used in an image forming apparatus such as an electrostatic copying machine or a laser printer.

In an electrophotographic method, an electrostatic latent image is formed on a photoreceptor, followed by developing the electrostatic latent image with a toner so as to form a toner image. Then, the toner image is transferred onto a transfer material such as a paper sheet, followed by fixing the toner image transferred onto the transfer material by, for example, a heating and pressurizing means.

The method most widely used nowadays in the fixing process is a heating-pressurizing method using a heat roller. In the heat roller system, a transfer material having an unfixed toner image transferred thereonto is passed along the surface of a heat roller formed of a material having a releasability relative to the toner such that the unfixed toner imager is brought into contact under pressure with the surface of the heat roller so as to permit the toner image to be fixed to the transfer material. In the heat roller system, however, it is necessary to maintain the temperature of the heat roller to fall within an appropriate range, in order to prevent problems such as defective fixing and the offset phenomenon in which the toner is migrated into the heat roller. These problems are caused by the passage of toner and transfer material and by changes in the temperature of the heat roller caused by other factors. Under the circumstances, it is necessary to increase the heat capacity of the heat roller or the heating medium, leading to the requirement of more electric power.

In order to overcome the above-noted problems inherent in the fixing system, it was necessary to develop a toner that can be fixed under a wider temperature range, and various toners have been developed to date including, for example, a toner that contains a substance capable of improving the releasability, such as polypropylene wax for preventing the offset phenomenon, a toner using a crosslinked resin, and a toner containing a wax that is melted under temperatures not higher than 90° C. for permitting the toner to be fixed under a lower temperature.

In recent years, known as a method of lowering the fixing temperature is a method of using a toner containing a crystalline polyester resin and an amorphous polyester resin as a binder resin, as disclosed in, for example, Japanese Patent Document No. 2001-222138.

However, such toners developed to date are incapable of satisfying all the demands, and some problems remain unsolved. For example, some of the prior art toners, which are excellent in the resistance to the generation of the high temperature offset phenomenon and in the developing properties, are insufficient in the fixing properties under low temperatures. Also, the other prior art toners, which are excellent in the resistance to the generation of the offset phenomenon under low temperatures and in the fixing properties under low temperatures, are somewhat unsatisfactory in the resistance to the blocking and are low in the developing properties. It follows the toners developed to date are incapable of satisfying simultaneously the resistance to the generation of the offset phenomenon under both the low temperature and the high temperature.

### BRIEF SUMMARY OF THE INVENTION

An object of the present invention, which has been achieved in an attempt to overcome the above-noted problems inherent in the prior art, is to provide a developing agent exhibiting a satisfactory fixing performance under a wide temperature range.

According to an aspect of the present invention, there is provided a developing agent, comprising a binder resin containing a polyester resin, a crystalline polyester resin having a DSC heat absorption peak at a first temperature, a first hydrocarbon series wax having a DSC heat absorption peak at a second temperature not higher than the first temperature, and second hydrocarbon series wax having a DSC heat absorption peak at a third temperature higher than the first temperature; and a coloring agent.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the present invention.

FIG. 1 is a graph exemplifying the DSC measurement;

FIG. 2 is a graph showing the relationship between the melt viscosity and the temperature in respect of an amorphous polyester resin and a crystalline polyester resin; and

FIG. 3 schematically exemplifies the construction of a fixing device used for measuring the characteristics of the developing agent.

### DETAILED DESCRIPTION OF THE INVENTION

The developing agent of the present invention comprises toner particles each containing a binder resin and a coloring agent, and the binder resin used in the present invention contains a polyester resin, a crystalline polyester resin, and at least two kinds of wax, differing in the DSC heat absorption peak.

In the present invention, the crystalline polyester resin has a DSC heat absorption peak at a first temperature, the first wax has a DSC heat absorption peak at a second temperature, not higher than the first temperature, and the second wax has a DSC heat absorption peak at a third temperature, higher than the first temperature.

According to the present invention, use of the binder resin described above makes it possible to obtain a developing agent which permits broadening the range within which the offset phenomenon is not generated and also permits exhibiting a satisfactory fixing performance over a wide temperature range, without impairing the manufacturing properties and the storing properties of the developing agent, even if a plurality of waxes are contained in the binder resin.

The DSC heat absorption peak defining the binder resin contained in the developing agent of the present invention represents a peak observed in a graph denoting the change in the heat amount measured by a differential scanning calorimeter DSC 210 manufactured by Seiko Denshi Kogyo K.K., covering the case where the target object to be measured is heated from room temperature to 200° C. at a rate of 10° C./min, retained at 200° C. for 10 minutes, cooled at a rate of 10° C./min and, then, heated again at a rate of 10° C./min.

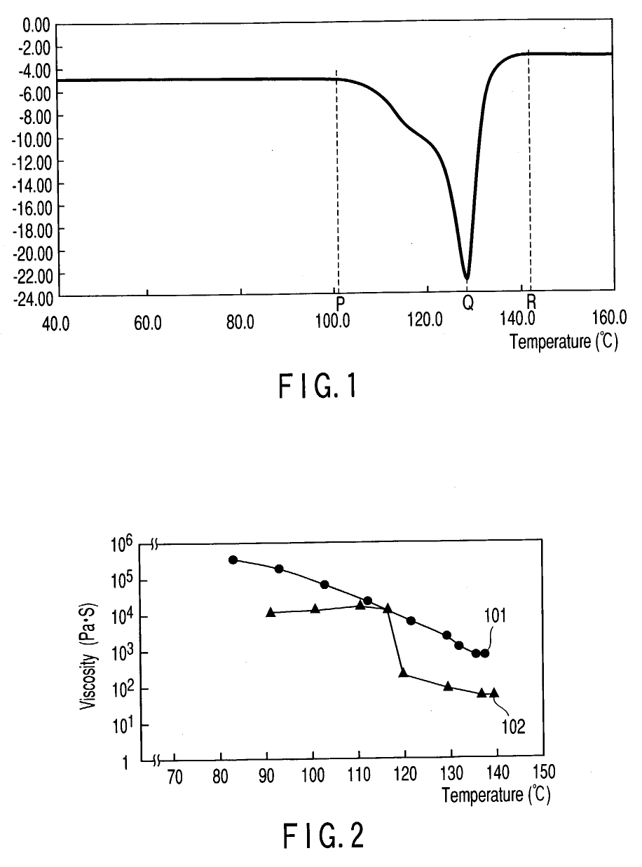

FIG. 1 is a graph showing the results of DSC measurement in respect of a sample of the resin used in the present invention.

As shown in FIG. 1, there is a heat absorption peak on point Q on a curve 101. The temperature at the heat absorption peak Q is 128.4° C., in this case. Also, point P on the curve 101 denotes the starting point of heat absorption, and point R denotes the end point of heat absorption. The starting temperature of heat absorption is 101.0° C., and the temperature at the end point of heat absorption is 142.4° C., in this case.

Also, the value obtained by dividing the total amount of absorbed heat (J), which is converted from the area defined by the straight line joining the points P and R and the portion of the curve 101 positioned between the points P and R, by the weight (g) of the sample, is defined as the heat absorption amount (J/g). In this sample, the heat absorption amount is 55.281 J/g.

The polyester resin used in the present invention can be obtained by using a monomer which is amorphous and contains a carboxylic acid component consisting of a polyhydric carboxylic acid compound having a valency of, for example, two or more, and an alcohol component consisting of a polyhydric alcohol having a valency of two or more.

The acid component used in the present invention includes, for example, fumaric acid, maleic acid, citraconic acid, itaconic acid, glutaric acid, phthalic acid, isophthalic acid, terephthalic acid, cyclohexane dicarboxylic acid, succinic acid, adipic acid, sebacic acid, azelaic acid, malonic acid, or a derivative including a succinic acid derivative in which is substituted an alkyl group having 1 to 20 carbon atoms or an alkenyl group having 2 to 20 carbon atoms such as dodecenyl succinic acid or octyl succinic acid, an anhydride of these acids, and an alkyl ester. On the other hand, the alcohol component used in the present invention includes, for example, aliphatic polyols such as ethylene glycol, propylene glycol, 1,4-butanediol, 1,3-butanediol, 1,5-pentanediol, 1,6-hexanediol, neopentane glycol, glycerin, trimethylol ethane, trimethylol propane, and pentaerythritol; alicyclic polyols such as 1,4-cyclohexane diol, and 1,4-cyclohexane dimethanol; and ethylene oxide such as bisphenol A or a propylene oxide adduct. It is desirable for the polyester resin used in the present invention to have a softening point falling within a range of between 100° C. and 160° C.

It is desirable for the mixing ratio by weight between the polyester resin and the crystalline polyester resin to fall within a range of between 50:50 and 95:5. If the mixing ratio falls within the range specified in the present invention, it is possible to obtain the merit that good fixing properties and good manufacturing properties, particularly, the pulverizing properties, can be obtained simultaneously. On the other hand, if the mixing ratio fails to fall within the range specified in the present invention, a defective fixing tends to be generated. In addition, the manufacturing process including the pulverizing step tends to be rendered troublesome.

The crystalline polyester resin used in the present invention differs from the ordinary polyester resin that is amorphous in that, in the crystalline polyester resin, a heat absorption peak appears on the graph prepared by the DSC measurement. In the crystalline polyester resin used in the present invention, it is desirable for the temperature of the heat absorption peak, i.e., a first temperature, to fall within a range of between 50° C. and 150° C. Use of this crystalline polyester resin produces the merit that a good resistance to blocking and a good fixing performance can be obtained simultaneously. If the first temperature is lower than 50° C., the blocking resistance tends to be rendered poor. On the other hand, if the first temperature exceeds 150° C., the lowest fixing temperature, i.e., the lowest temperature at which the fixing can be achieved, tends to be elevated. It is more desirable for the first temperature to fall within a range of between 80° C. and 140° C.

It is desirable for the DSC heat absorption amount of the crystalline polyester resin to fall within a range of between 10 and 120 J/g. If the DSC heat absorption amount is smaller than 10 J/g, the blocking resistance tends to be rendered poor. On the other hand, if the DSC heat absorption amount exceeds 120 J/g, the fixing performance tends to be rendered poor.

If the DSC heat absorption peak temperatures of the two kinds of wax and the DSC heat absorption peak temperature of the crystalline polyester resin satisfy the relationship given above, it is possible to broaden further the range in which the offset phenomenon is not generated so as to make it possible to achieve a stable fixing under a broader temperature range.

It is desirable for the second temperature of the first wax to fall within a range of between 65° C. and 100° C. On the other hand, it is desirable for the third temperature of the second wax to fall within a range of between 100° C. and 150° C. Further, it is desirable for the difference between the second temperature and the third temperature to fall within a range of between 10° C. and 80° C. On the other hand, it is desirable for the difference between the first temperature and the second temperature to fall within a range of between 0° C. and 40° C., and it is desirable for the difference between the first temperature and the third temperature to fall within a range of between 0° C. and 40° C.

Also, even in the case of using at least three different kinds of wax in combination, it is desirable for the combination to include a wax having a heat absorption peak temperature not higher than the heat absorption peak temperature of the crystalline polyester resin and another wax having a heat absorption peak temperature higher than the heat absorption peak temperature of the crystalline polyester resin.

If the DSC heat absorption peak temperatures of a plurality of different waxes and the DSC heat absorption peak temperature of the crystalline polyester resin satisfy the relationship given above, it is possible to broaden further the range in which the offset phenomenon is not generated, so as to make it possible to achieve stable fixing under a broader temperature range.

The crystalline polyester resin used in the present invention includes, for example, a polyester series resin that can be obtained by using a monomer containing a carboxylic acid component consisting of a polyhydric carboxylic acid compound having a valency of, for example, two or more, and an alcohol component consisting of a polyhydric alcohol having a valency of two or more.

The difference between the crystalline characteristics and the amorphous characteristics will now be described with reference to a graph showing the melting characteristics.

FIG. 2 is a graph showing the relationship between the melt viscosity and the temperature in respect of a crystalline polyester resin having a softening point of 120° C. and an amorphous polyester resin having a softening point of 105° C.

As apparent from curve 101 shown in FIG. 2, the viscosity of the amorphous polyester resin is gradually decreased with the elevation of temperature, over a wide temperature range. On the other hand, the crystalline polyester resin denoted by curve 102 has a narrow temperature range within which the viscosity is rapidly lowered with elevation of temperature.

The acid component of the crystalline polyester resin used in the present invention includes, for example, fumaric acid, maleic acid, citraconic acid, itaconic acid, glutaric acid, phthalic acid, isophthalic acid, terephthalic acid, cyclohexane dicarboxylic acid, succinic acid, adipic acid, sebacic acid, azelaic acid, malonic acid, or a derivative including a succinic acid derivative in which is substituted an alkyl group having 1 to 20 carbon atoms or an alkenyl group having 2 to 20 carbon atoms such as dodecenyl succinic acid or octyl succinic acid, an anhydride of these acids, and an alkyl ester. On the other hand, the alcohol component of the crystalline polyester resin used in the present invention includes, for example, aliphatic polyols such as ethylene glycol, propylene glycol, 1,4-butanediol, 1,3-butanediol, 1,5-pentanediol, 1,6-hexanediol, neopentane glycol, glycerin, trimethylol ethane, trimethylol propane, and pentaerythritol; alicyclic polyols such as 1,4-cyclohexane diol, and 1,4-cyclohexane dimethanol; and ethylene oxide such as bisphenol A or a propylene oxide adduct.

Particularly, it is desirable to use a crystalline polyester resin having an alkyl or alkenyl group having at least 16 carbon atoms. The crystalline polyester resin meeting this requirement, which can be obtained by polycondensation between an alcohol component containing at least 80 mol % of diols having 2 to 6 carbon atoms and a carboxylic acid component containing at least 80 mol % of fumaric acid, is generally a waxy crystalline compound. It is desirable for this crystalline polyester resin to have a softening point of 50 to 150° C., a glass transition point of 50 to 150° C., and a difference between the melting point and the glass transition point of 0.1 to 10° C. It is possible to use a single kind of the crystalline polyester resin or a plurality of crystalline polyester resins in combination.

The hydrocarbon series wax used in the present invention, which is not particularly limited, includes, for example, aliphatic hydrocarbon series waxes such as a low molecular weight polyethylene, a low molecular weight polypropylene, a polyolefin wax, a microcrystalline wax, a paraffin wax, and a Fischer-Tropsch wax; plant waxes such as an oxide of aliphatic hydrocarbon series wax such as an oxidized polyethylene wax, a block copolymer thereof, candelilla wax, carnauba wax, Japan wax, jojoba wax, and rice wax; animal waxes such as bees wax, lanolin, and whale wax; waxes containing fatty acid esters as main components such as montanic acid ester wax, and castor wax; and waxes having the fatty acid ester deoxidized partially or entirely such as deoxidized carnauba wax. The hydrocarbon series wax used in the present invention also includes, for example, saturated linear fatty acids such as palmitic acid, stearic acid, montanic acid and a long chain alkyl carboxylic acid having a long chain alkyl group; unsaturated fatty acids such as brassidic acid, eleostearic acid, and palinaric acid; saturated alcohols such as stearyl alcohol, eicosyl alcohol, behenyl alcohol, carnaubyl alcohol, ceryl alcohol, melissyl alcohol and a long chain alkyl alcohol having a long chain alkyl group; polyhydric alcohols such as sorbitol; fatty acid amides such as linoleic acid amide, oleic acid amide and lauric acid amide; saturated fatty acid amides such as methylene bis-stearic acid amide, ethylene bis-capric acid amide, ethylene bis-lauric acid amide, and hexamethylene bis-stearic acid amide; unsaturated fatty acid amides such as ethylene bis-oleic acid amide, hexamethylene bis-oleic acid amide, N,N′-dioleyl adipic acid amide, and N,N′-dioleyl sebacic acid amide; aromatic bis-amides such as m-xylene bis-stearic acid amide, and N,N′-distearyl isophthalic acid amide; waxes prepared by grafting vinyl monomers such as styrene or acrylic acid to an aliphatic hydrocarbon series wax; partial ester compounds between a fatty acid such as behenic acid monoglyceride and a polyhydric alcohol; and methyl ester compounds having a hydroxyl group, which are obtained by hydrogenation of the plant fat and oil.

The coloring agent used in the present invention includes, for example, a carbon black and organic or inorganic pigment or dye. The carbon black used in the present invention includes, for example, acetylene black, furnace black, thermal black, channel black and Ketchen black. On the other hand, the pigment and dye used in the present invention include, for example, fast yellow IG, benzidine yellow, indofast orange, irugadine red, carmine FB, permanent bordeaux FRR, pigment orange R, lithol red 2G, lake red C, rhodamine FB, rhodamine lake, phthalocyanine blue, pigment blue, brilliant green, phthalocyanine green and quinacridone. These pigments and dyes can be used singly or in combination.

It is possible to add a charge control agent for controlling the amount of the frictional charge to the developing agent of the present invention. The charge control agent used in the present invention includes, for example, negative polarity control agents such as a metal chelate of alkyl salicylic acid, a chlorinated polyester, a polyester having an excessively large amount of the acid group, a chlorinated polyolefin, a metal salt of a fatty acid, and a fatty acid soap as well as positive polarity control agents such as a nigrosine series dye, a quaternary ammonium salt, and an amine compound.

In order to control the flowability and the charging properties, it is possible for the developing agent of the present invention to contain 0.2 to 3% by weight of inorganic particles based on the toner particles.

The inorganic particles used in the present invention include, for example, particles of silica, titania, alumina, strontium titanate and tin oxide. These inorganic particles can be used singly or in combination. Also, it is desirable to use the inorganic particles having the surface treated with a hydrophobic agent in view of the improvement in the environmental stability.

Also, in order to improve the cleaning properties of the developing agent, it is possible for the toner to be added to fine resin particles having a diameter not larger than 11 μm, which are obtained by polymerizing monomers such as styrene, acrylic acid, methyl methacrylate, butyl acrylate and ethyl hexyl acrylate. These monomers can be used singly or in combination in obtaining the fine resin particles.

The toner particles used in the developing agent of the present invention can be obtained by, for example, dispersing, mixing and melt kneading a coloring agent and a binder resin, followed by roughly pulverizing, then, finely pulverizing the resultant kneaded mass and subsequently classifying the pulverized material.

The mixer used in the dispersing step includes, for example, a Henschel mixer (manufactured by Mitsui Kozan K.K.), a super mixer (manufactured by Kawata Inc.), a Ribocone (manufactured by Ogawara Seisakusho K.K.), a Nowter mixer, a Turbulizer, a cyclomix (manufactured by Hosokawa micron Inc.), a spiral pin mixer (manufactured by Taiheiyo Kiko Inc.), and a Ladigge mixer (manufactured by Matsubo Inc.).

The kneader used in the kneading step includes, for example, a KRC kneader (manufactured by Kurimoto Tekkosho K.K.), a Buss co-kneader (manufactured by Buss Inc.), a TEM type extruder (manufactured by Toshiba Kikai K.K.), a TEX biaxial kneader (manufactured by Nippon Seikosho Inc.), a PCM kneader (manufactured by Ikegai Tekkosho K.K.), a three-roll mill, a mixing roll mill, a kneader (manufactured by Inoue Seisakusho K.K.), an MS type pressurizing kneader, a kneader ruder (manufactured by Moriyama Seisakusho K.K.) and Banbury mixer (manufactured by Kobe Seikosho K.K.).

In the step of roughly pulverizing the mixture, it is possible to use, for example, a hammer mill, a cutter mill, a jet mill, a roller mill and a ball mill.

In the step of finely pulverizing the roughly pulverized material, it is possible to use, for example, a counter jet mill, a micron jet, an inomizer (manufactured by Hosokawa Micron Inc.), an IDS type mill, a PJM jet pulverizer (manufactured by Nippon Pneumatic Kogyo K.K.), a cross jet mill (manufactured by Kurimoto Tekkosho K.K.), an Ullumax (manufactured by Nisso Engineering Inc.), an SK jet oh mill (manufactured by Seishin Inc.), a Kryptron (manufactured by Kawasaki Jukogyo K.K.), and a turbo mill (manufactured by Turbo Kogyo K.K.).

Further, the classifying machine used in the present invention for classifying the finely pulverized material includes, for example, a Classiel, a micron classifier, a Spedic classifier (manufactured by Seishin Inc.), a turbo classifier (manufactured by Nisshin Engineering Inc.), a micron separator, a turboplex (ATP), a TSP separator (manufactured by Hosokawa Micron Inc.), an elbow jet (manufactured by Nittetsu Kogyo K.K.), a dispersion separator (manufactured by Nippon Pneumatic Kogyo Inc.) and a YM micro cut (manufactured by Yasukawa Shoji K.K.).

The mixer described above can be used as a means for mixing and attaching the additive to the surface of the toner particle. The sieving apparatus used in the present invention for sieving the coarse particles includes, for example, an Ultrasonic (manufactured by Koei Sangyo K.K.), a resona sieve, a Jairo shifter (manufactured by Tokuju Kosakusho K.K.), a Vibrasonic system (manufactured by Dalton Inc.), a Sonyclean (manufactured by Nitto Kogyo K.K.), a micro shifter, and a circular vibrating sieve.

The present invention will now be described more in detail with reference to Examples.

### EXAMPLE 1

The raw materials of the toner particles given below were dispersed in an air stream type mixer, followed by kneading the dispersed raw materials in a biaxial extruder.

After kneading, the resultant sheet of the kneaded material was roughly pulverized by using a mechanical pulverizer into a powdery material having a particle diameter of about 1 mm, followed by further pulverizing the roughly pulverized powdery material by using an ultrasonic jet pulverizing machine into a finely pulverized powdery material having an average volume particle diameter of 7 μm and subsequently classifying the finely pulverized powdery material by using an air stream classifying machine.

In order to evaluate the manufacturing capability of the developing agent, the pulverizing capability of the toner particle was examined. Table 1 shows the results. The mark “◯” shown in Table 1 denotes that the toner particles can be continuously pulverized under a prescribed air pressure, with the mark “x” denoting that it was impossible to continuously pulverize the toner particles.

The toner particles tested were found to be capable of being pulverized continuously under a prescribed air pressure and, thus, there was no problem in the pulverizing capability (manufacturing capability).

Raw Materials of Toner Particles:

| | |
|---|---|
| Resin 1 (polyester resin having a softening point | 70 parts by weight |
| of 110° C.) | |
| Resin 2 (crystalline polyester resin particles | 20 parts by weight |
| having a DSC heat absorption peak at 100° C.) | |
| Pigment (carbon black) | 5 parts by weight |
| Wax 1 (carnauba wax having a DSC heat absorption | 2 parts by weight |
| peak at 80° C.) | |
| Wax 2 (polypropylene wax having a DSC heat | 2 parts by weight |
| absorption peak at 130° C.) | |
| CCA (colored metal complex) | 1 part by weight |

Silica in an amount of 0.4 parts by weights was mixed with 100 parts by weight of the toner thus obtained so as to apply a surface treatment to the toner particles to obtain a desired toner.

The toner thus obtained was set in a Premage 455 (trade name of a copying machine manufactured by Toshiba Tec K.K. and improved for the use for evaluation) so as to form an image. The fixing device portion of the copying machine was revised for the purpose of evaluation.

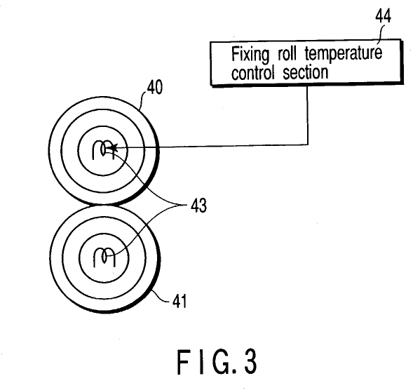

FIG. 3 exemplifies the construction of the fixing device used for the evaluation test of the developing agent of the present invention. The fixing device is revised such that the temperature of the fixing roll is variable. As shown in the drawing, the fixing device comprises a hard roller 40, a rubber roller 41 arranged to face the hard roller 40, a heat source 43 arranged in each of the hard roller 40 and the rubber roller 41, and a temperature control section 44 of the fixing roll connected to the heat source 43. The hard roller 40 and the rubber roller 41 are pressed against each other with a prescribed pressure and arranged to have a prescribed nip width. An unfixed image was fixed by using the this fixing device.

The fixed image thus obtained was evaluated in respect of the highest fixing temperature, the lowest fixing temperature and the temperature range within which an offset phenomenon was not generated.

The test and evaluation were conducted as follows. In the first step, the temperature of the heating rollers included in the fixing device was elevated stepwise from 120° C. to 240° C. at 5° C. intervals. In this state, a transfer paper sheet having an unfixed toner image transferred thereonto was supplied into the nip portion between the hard roller 40 and the rubber roller 41 at each temperature under the conditions that the load was 400 N, the nip width was 7.5 mm, and the feeding rate of the transfer paper sheet was 200 mm/sec so as to fix the unfixed toner image to the transfer paper sheet and to measure the image density of the fixed image thus formed. Then, friction was applied to the image portion by using a fastness tester manufactured by K.K. Daiei Kagaku Seiki Seisakusho, followed by measuring again the image density. The fixation remaining rate was obtained by the formula:

A=B/C×100(%),

where “A” represents the fixation remaining rate, “B” represents the image density after the friction, and “C” represents the image density before the friction.

The temperature at which at least 80% of the fixation remaining rate can be obtained was obtained as the lowest fixing temperature. Also, the upper limit of the temperatures at which the fixing can be achieved without generating a high temperature offset phenomenon was judged by visual observation of a chart so as to obtain the highest fixing temperature.

For determining the temperature range within which the offset phenomenon is not generated, the fixing treatment was applied to the unfixed toner image transferred onto the transfer paper sheet under the conditions described above, and the operation to observe whether or not the stain with the toner was generated was conducted under the state that the set temperature of the heating rollers included in the fixing device was successively elevated stepwise so as to determine the temperature range within which the stain with the toner was not generated. In other words, the temperature range within which any of a low temperature offset phenomenon generated at a low temperature region and a high temperature offset phenomenon generated at a high temperature region was not generated was determined as the temperature range within which the offset phenomenon is not generated.

The fixation remaining rate of the image fixed under temperatures not lower than 125° C. has been found to be 80% or more, supporting that it was possible to obtain a satisfactory image having a sufficiently high fixation strength. Also, a poor image, i.e., a so-called high temperature offset phenomenon, was not generated in the image fixed under temperatures not higher than 210° C. so as to obtain a good image. In other words, it has been found that a good image having a sufficiently high fixing strength can be obtained under the temperatures ranging between 125° C. and 210° C. Table 1 shows the results of the tests.

Incidentally, it is desirable for the temperature range within which the offset phenomenon is not generated to be at least 60° C. in view of the nonuniformity of the fixing device.

It is desirable for the lowest fixing temperature to be not higher than 135° C. in view of energy saving. Also, it is desirable for the non-offset range, i.e., the temperature range within which the offset phenomenon is not generated, to be at least 60° C. in view of nonuniformities in the fixing device.

In order to evaluate the storage capability, the obtained toner was left to stand under an atmosphere of 50° C. for at least 8 hours so as to examine the blocking resistance by visual observation of the agglomerated lumps. Table 1 shows the results. The mark “◯” given in Table 1 denotes that agglomerated lumps were not generated, and the mark “x” denotes that they were. As apparent from Table 1, agglomerated lumps were not generated.

Table 1 shows the pulverization capability, the highest fixing temperature, the lowest fixing temperature, the non-offset range, and the blocking resistance thus obtained.

### EXAMPLES 2 to 5

A desired toner for electrophotography was manufactured under the conditions equal to those for Example 1, except that the DSC heat absorption peak of the crystalline polyester resin particles was changed as shown in Table 1, and testing and evaluation were conducted as in Example 1. Table 1 shows the results.

### EXAMPLES 6 to 9

A toner was manufactured as in Example 1, except that the content of the crystalline polyester resin particles in the binder resin was changed as shown in Table 1, and testing and evaluation were conducted as in Example 1. Table 1 shows the results.

### EXAMPLES 10 to 13

A toner was manufactured as in Example 1, except that the kind of the wax used was changed as shown in Table 1, and testing and evaluation were conducted as in Example 1. Table 1 shows the results.

### COMPARATIVE EXAMPLES 1 and 2

A toner was manufactured as in Example 1, except that one of the first and second waxes was not used, and testing and evaluation were conducted as in Example 1. Table 1 shows the results.

TABLE 1

| | Crystalline | | | | | | | | |
|---|---|---|---|---|---|---|---|---|---|
| | resin particles | | Wax 1 | Wax 2 | Lowest | Highest | Non- | | |
| | DSC | | DSC | DSC | fixing | fixing | offset | Pulveriza- | Blocking |
| | peak | Content | peak | peak | temperature | temperature | region | tion | resis- |
| | (° C.) | (wt %) | (° C.) | (° C.) | (° C.) | (° C.) | (° C.) | capability | tance |
| Examples | | | | | | | | | |
| 1 | 100 | 20 | 80 | 130 | 125 | 200 | 75 | ◯ | ◯ |
| 2 | 50 | ″ | ″ | ″ | 120 | 195 | 75 | ◯ | ◯ |
| 3 | 150 | ″ | ″ | ″ | 135 | 220 | 85 | ◯ | ◯ |
| 4 | 45 | 20 | 80 | 130 | 125 | 200 | 75 | ◯ | X |
| 5 | 155 | ″ | ″ | ″ | 145 | 220 | 75 | X | ◯ |
| 6 | 100 | 5 | ″ | ″ | 135 | 220 | 85 | ◯ | ◯ |
| 7 | ″ | 50 | ″ | ″ | 120 | 190 | 70 | ◯ | ◯ |
| 8 | 100 | 4 | ″ | ″ | 140 | 220 | 80 | ◯ | ◯ |
| 9 | ″ | 51 | ″ | ″ | 120 | 200 | 80 | X | ◯ |
| 10 | ″ | 20 | 100 | 130 | 130 | 215 | 85 | ◯ | ◯ |
| 11 | ″ | 20 | 105 | | 145 | 220 | 75 | ◯ | ◯ |
| 12 | ″ | 20 | 80 | 100 | 120 | 160 | 40 | ◯ | ◯ |
| Comparative | | | | | | | | | |
| examples | | | | | | | | | |
| 1 | ″ | 20 | None | 130 | 160 | 180 | 20 | ◯ | ◯ |
| 2 | ″ | 20 | 80 | None | 135 | 155 | 20 | ◯ | ◯ |

Where the DSC heat absorption peak of the crystalline polyester resin particles falls within a range of between 50° C. and 150° C. as in Examples 2 and 3, the non-offset region, i.e., the temperature range within which the offset phenomenon is not generated, is wide. In addition, the blocking resistance and the pulverization capability were found to be satisfactory.

It has also been found that, where the DSC heat absorption peak of the crystalline polyester resin particles is lower than 50° C. as in Example 4, the blocking resistance tends to be rendered poor. Also, it has been found that, where the DSC heat absorption peak noted above is higher than 150° C., as in Example 5, the pulverization capability tends to be rendered poor. It follows that it is desirable for the DSC heat absorption peak of the crystalline polyester resin particles to fall within a range of between 50° C. and 150° C.

It has been found that, where the content of the crystalline polyester resin particles falls within a range of between 5 and 50 parts by weight as in Examples 6 and 7, the non-offset region is wide. Also, the blocking resistance and the pulverization capability have been found satisfactory.

It has been found that, where the content of the crystalline polyester resin particles is lower than 5 parts by weight, as in Example 8, the low temperature fixing performance tends to be rendered poor. On the other hand, it has been found that, where the content of the crystalline polyester resin particles exceeds 50 parts by weight as in Example 9, the pulverization capability tends to be rendered poor. It follows that it is desirable for the content of the crystalline polyester resin particles to fall within a range of between 15 and 50 parts by weight.

It has also been found that, in the case where a wax having a DSC heat absorption peak not higher than that of the crystalline polyester resin particles is used in combination with a hydrocarbon series wax having a DSC heat absorption peak not lower than that of the crystalline polyester resin particles as in, for example, Example 10, it is possible to realize both a low temperature fixing and a wide non-offset region.

However, where each of the first and second waxes has a DSC heat absorption peak higher than that of the crystalline polyester resin particles, as in Example 11, it has been found that the lowest fixing temperature tends to be elevated.

Further, where the crystalline polyester resin particles have a DSC heat absorption peak equal to that of the second wax as in Example 12, it has been found that the non-offset range tends to be narrowed.

Incidentally, it has been found that, where only one kind of wax is used as in each of Comparative Examples 1 and 2, the non-offset region is rendered vary narrow.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A developing agent, comprising a binder resin containing a polyester resin, a crystalline polyester resin having a DSC heat absorption peak at a first temperature, a first hydrocarbon series wax having a DSC heat absorption peak at a second temperature not higher than the first temperature, and a second hydrocarbon series wax having a DSC heat absorption peak at a third temperature higher than the first temperature; and a coloring agent.

2. A developing agent according to claim 1, wherein the mixing ratio by weight of the polyester resin to the crystalline polyester resin falls within a range of between 50:50 and 95:5.

3. A developing agent according to claim 1, wherein the first temperature falls within a range of between 50° C. and 150° C.

4. A developing agent according to claim 1, wherein the crystalline polyester resin has 10 to 120 J/g of heat absorption amount at its DSC heat absorption peak.

5. A developing agent according to claim 1, wherein the second temperature falls within a range of between 65° C. and 100° C.

6. A developing agent according to claim 1, wherein the third temperature falls within a range of between 100° C. and 150° C.

7. A developing agent according to claim 1, wherein the difference between the second temperature and the third temperature falls within a range of between 10° C. and 80° C.

8. A developing agent according to claim 1, wherein the difference between the first temperature and the second temperature falls within a range of between 0 and 40° C., and the difference between the first temperature and the third temperature falls within a range of between 0 and 40° C.
